(19) United States
(12) Patent Application Publication
(10) Pub. No.: US 2015/0234644 A1
(43) Pub. Date: Aug. 20, 2015

(54) AUTOMATIC COLLECTION AND PROVISIONING OF RESOURCES TO MIGRATE APPLICATIONS FROM ONE INFRASTRUCTURE TO ANOTHER INFRASTRUCTURE

(71) Applicant: EMPIRE TECHNOLOGY DEVELOPMENT LLC, WILMINGTON, DE (US)

(72) Inventor: Ramanathan Ramanathan, Bellevue, WA (US)

(21) Appl. No.: 14/383,370

(22) PCT Filed: Feb. 10, 2014
(86) PCT No.: PCT/US14/15648

§ 371 Date: Sep. 5, 2014

(51) Int. Cl. G06F 9/445; H04L 12/911; H04L 29/08

(52) U.S. Cl. CPC G06F 8/60; H04L 67/1095; H04L 47/82; H04L 67/16

(57) ABSTRACT

Technologies are provided for maintenance of resources in the migration of applications between datacenters through use of a migration module. In some examples, the migration module may collect information such as, by way of example, service provisions from a source datacenter in an idle state and in one or more active states of the applications being migrated. The migration module may test to ensure the collected information is accurate and may provide a mechanism for a customer to re-adjust the collected service provisions. Information may be packaged with the application and moved to the destination datacenter. In the destination datacenter, the migration module may collect the service provisions, build a model, and determine the successful deployability of the application. Once the migration module tests the deployment multiple times for each application state, the destination datacenter may be re-provisioned until the required service provisions are met.

### BACKGROUND

Unless otherwise indicated herein, the materials described in the background section is not prior art to the claims in the application and is not admitted to be prior art by inclusion in the section.

Cloud-based infrastructures allow customers (tenants) and organizations to access computational resources at various levels. The customers may move an application from one cloud-based infrastructure to another cloud-based infrastructure, but may face problems in the migration of the application (including performance and service level of the migrating application) and the maintenance of service parameters in the destination cloud-based infrastructure. The service parameters may include server processing, networking, cost, server processing capacity, and similar ones, which may not be implemented equivalently by different service providers. As such, it is unlikely that the computing environment of the cloud-based infrastructure may be a replica of the environment of another cloud-based infrastructure, making the migration of the application from one infrastructure to another difficult. Difficulties in the migration of the application from one cloud-based infrastructure to another may involve the re-engineering of the application in order for the application to function.

### SUMMARY

The present disclosure generally describes techniques to maintain resources in the migration of applications between datacenters through use of a migration module.

According to some embodiments, a method to maintain resources in the migration of an application between datacenters is described. An example method may include collecting information associated with one or more resources for an execution of the application at an origin datacenter in one or more application states, determining corresponding resources associated with a deployment of the application at a destination datacenter, constructing a model for the deployment of the application at the destination datacenter based on the corresponding resources, and determining a likelihood of successful deployment of the application at the destination datacenter based on the collected information and the model.

According to further embodiments, a computing device to maintain resources in the migration of an application between datacenters may include a memory and a processor coupled to the memory and adapted to execute a migration module. The migration module may collect information associated with one or more resources for an execution of the application at an origin datacenter in one or more of an idle application state and one or more active application states, determine corresponding resources associated with a deployment of the application at a destination datacenter, construct a model for the deployment of the application at the destination datacenter based on the corresponding resources, determine a likelihood of successful deployment of the application at the destination datacenter based on the collected information and the model, package one or more of the collected information and the model with the application, and transfer the packaged application to the destination datacenter for the deployment.

According to further embodiments, a migration service to maintain resources in the migration of an application between datacenters may include a first migration module, a second migration module, and a coordination module. The first migration module may be configured to collect information associated with one or more resources for an execution of the application at an origin datacenter in one or more of an idle application state and one or more active application states. The second migration module may be configured to determine corresponding resources associated with a deployment of the application at a destination datacenter. The coordination module may be configured to construct a model for the deployment of the application at the destination datacenter based on the corresponding resources at the destination datacenter, determine a likelihood of successful deployment of the application at the destination datacenter based on the collected information and the model, package one or more of the collected information and the model with the application, and transfer the packaged application to the destination datacenter for the deployment.

According to some embodiments, a computer readable storage medium with instructions stored thereon, which when executed on one or more computing devices executes a method for maintenance of resources in migration of an application between datacenters is described. An example method may include the actions described above.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings, in which:

FIG. 1 illustrates an example system, where maintenance of application performances upon transfer between cloud computing environments may be implemented;

FIG. 2 illustrates an example configuration of applications deployed over multiple virtual servers;

FIG. 3 illustrates application resources utilized to deliver the service provisions;

FIG. 4 illustrates the service provisions of application resources collected by a daemon;

FIG. 5 illustrates an example configuration of multiple application states of applications in an origin datacenter and a destination datacenter;

FIG. 6 illustrates an example configuration of a migration service configured to provide maintenance of resources in migration of the applications deployed over multiple virtual servers;

FIG. 7 illustrates a general purpose computing device, which may be used to provide maintenance of resources in migration of an application between at least two datacenters;

FIG. 8 illustrates a flow diagram illustrating an example method for providing maintenance of resources in migration of an application between at least two datacenters that may be performed by a computing device such as the computing device in FIG. 7; and

FIG. 9 illustrates a block diagram of an example computer program product utilizing a migration module, all arranged in accordance with at least some embodiments as described herein.

### DETAILED DESCRIPTION

In the following detailed description, reference is made to the accompanying drawings, which form a part hereof In the drawings, similar symbols generally identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

The present disclosure is generally drawn, inter alia, to methods, apparatus, systems, devices, and/or computer program products related to maintenance of resources in the migration of applications between datacenters through the use of a migration module.

Briefly stated, technologies are provided for maintenance of resources in the migration of applications between datacenters through use of a migration module. In some examples, the migration module may collect information such as, by way of example, service provisions from a source datacenter in an idle state and in one or more active states of the applications being migrated. The migration module may test to ensure the collected information is accurate and may provide a mechanism for a customer to re-adjust the collected service provisions. Information may be packaged with the application and moved to the destination datacenter. In the destination datacenter, the migration module may collect the service provisions, build a model, and determine the successful deployability of the application. Once the migration module tests the deployment multiple times for each application state, the destination datacenter may be re-provisioned until the required service provisions are met.

A datacenter, as used herein, refers to an entity that hosts services and applications for customers through a physical server installations and a virtual machine executed in those server installations. Customers of the datacenter, also referred to as tenants, may be organizations that provide access to their services by multiple customers. An example datacenter based service configuration may include an online retail service that provides retail sale services to consumers (customers). The retail service may employ multiple applications (e.g., presentation of retail goods, purchase management, shipping management, inventory management, etc.), which may be hosted by the datacenters. A consumer may communicate with those applications of the retail service through a client application such as a browser over networks and receive the provided service without realizing where the individual applications are actually executed. The scenario contrasts with current configurations, where each service provider would execute their applications and have their customers access those applications on the retail services own servers physically located on retail service premises. One result of the networked approach described herein is that customers like the retail service may move their hosted services/applications from the one datacenter to another datacenter without the customers noticing a difference.

A daemon, as used herein, refers to a computer program that may be executed unobtrusively as a background process, rather than under the direct control of a customer, until the daemon is activated by the occurrence of a specific event. A Unix-like system, for example, may execute numerous daemons to handle requests for services from other computers on a network. The daemon may respond to other programs and to hardware activity. An example of when a daemon becomes triggered to the active state may include a specific time or date, passage of a specified time interval, a file landing in a particular directory, receipt of an e-mail or a web request made through a particular communication line, etc.

A daemon may also be expressed as a process, where a process may be an executing instance of a program. On the Microsoft Windows® operating systems, programs called services may perform the functions of daemons, where the service may run as a process. Processes may be managed by the kernel, the core of the operating system. A process identification number (PID) may be automatically assigned to each process. Daemons may be recognized by the system as any processes whose parent process has a PID of one. The common technique for launching a daemon may involve forking (e.g., dividing) once or twice, forcing the parent and grandparent processes to die, while the child or grandchild process begin performing their normal function. In many Unix-like operating systems, each daemon may have a single script with which the daemon may be terminated, restarted, or have its status checked. Additionally, some daemons may be started manually, instead of being launched by the operating system and by an application program.

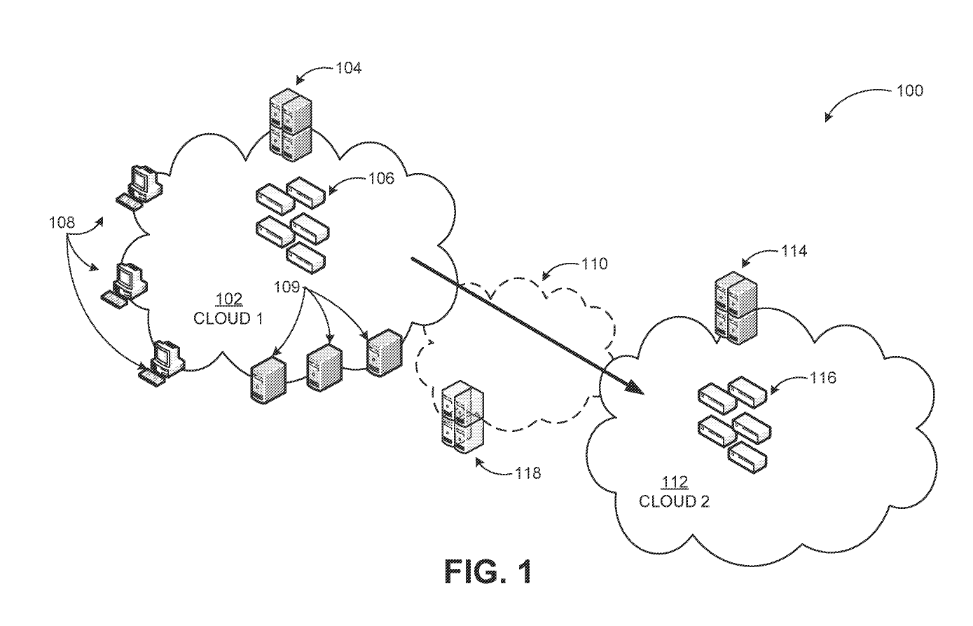

FIG. 1 illustrates an example system, where maintenance of application performances upon transfer between cloud computing environments may be implemented, arranged in accordance with at least some embodiments described herein.

As shown in a diagram 100, a service provider 102 (e.g., cloud environment 1) may host services such as applications, data storage, data processing, or comparable ones for individual or enterprise customers 108 and 109. The service provider 102 may include the datacenters providing the services and may employ a server 104 and/or a special purpose device 106 such as firewalls, routers, and so on. To provide services to the service providers' individual or enterprise customers 108 and 109, the service provider 102 may employ servers 104, special purpose devices, physical or virtual data stores, etc. An application hosted or data stored by the service provider 102 for a customer may involve a complex architecture of hardware and software components. The service level provided to the customer (e.g., owner of the hosted application or data) may be determined based on a number of service parameters such as a server processing capacity, a memory capacity, and a networking bandwidth, which may be implemented in a particular way by the service provider 102.

Cloud-based service providers may have disparate architectures and provide similar services but with distinct parameters. For example, data storage capacity, processing capacity, server latency, and similar aspects may differ from cloud to cloud. Furthermore, the service parameters may vary depending on the provided service.

As shown in the diagram 100, the service provider 102 (e.g., cloud environment 1) may be a source cloud. A service provider 112 (e.g., cloud environment 2) may be a target cloud in a migration process. Similar to the service provider 102, the service provider 112 may also employ servers (e.g. a server 114) and a special purpose device 116 to provide its services. Performance level determination and scoring may be managed and performed by the server 104 of the service provider 102, the server 114 of the service provider 112, or by third-party service executed a server 118 of another cloud 110.

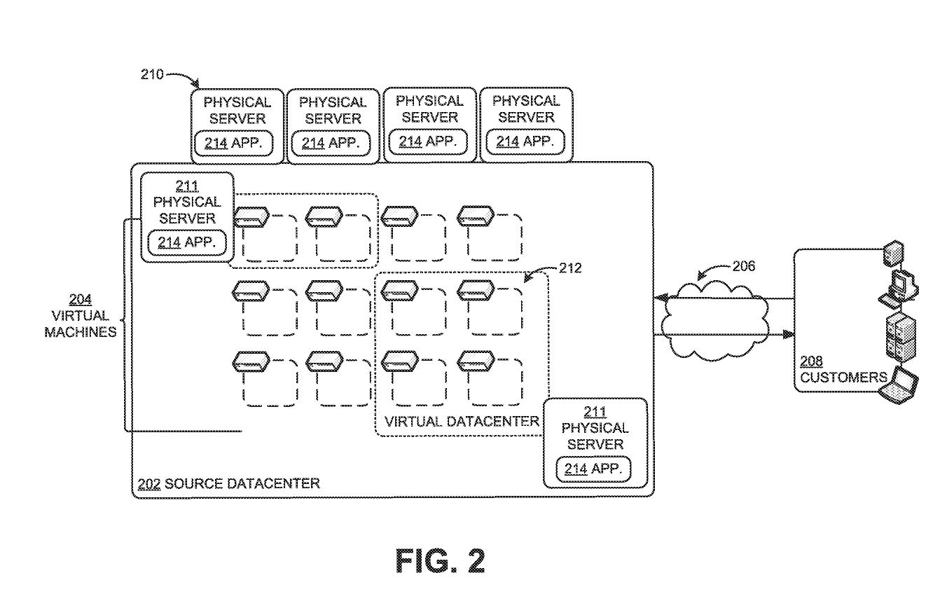

FIG. 2 illustrates an example configuration of applications deployed over multiple virtual servers, arranged in accordance with at least some embodiments described herein.

As shown in a diagram 200, a source datacenter 202 may include physical servers 210, 211, and 213, each of which may be configured to provide virtual machines 204. The physical servers 210, 211, and 213 may execute an application 214. The application 214 may include program data. For example, the physical servers 211 and 213 may be configured to provide the virtual machines 204. In some embodiments, the virtual machines 204 may be combined into virtual datacenters 212. For example, the virtual machines 204 provided by the physical server 211 may be combined into the virtual datacenter 212. The virtual machines 204 and/or the virtual datacenter 212 may be configured to provide cloud-related data/computing services such as applications, data storage, data processing, or comparable ones to a group of customers 208, such as individual customers or enterprise customers, via a cloud environment 206.

According to some embodiments, the physical servers 210, 211, and 213 may be configured to deploy the application 214 and/or a service. According to some embodiments, the group of customers 208 may wish to transfer the application 214 from the physical servers 210, 211, and 213. The transfer of the application 214 from the source datacenter 202 to the group of customers 208 may be difficult and performed manually. The transfer of the application 214 to the group of customers 208 may implement the virtual machines 204 through the cloud environment 206.

In a cloud-based application deployment, the group of customers 208 may be challenged by the migration of the application 214 from the cloud environment 206. The group of customers 208 may have to add additional services, add disk storage, optimize the databases, and re-engineer the application 214 in order to maintain application performance levels at the destination cloud environment. When transferring the application 214 from the source datacenter 202 to the group of customers 208, the operating system of the source datacenter 202 may not match the operating system used by the group of customers 208.

In some embodiments, the application 214 may be hosted in the virtual datacenter. In other examples, the operating system that the application 214 is part of may not match the operating system of the group of customers 208.

Cloud computing may refer to the use of both hardware and software computing resources to deliver a service over a network, where remote services may be delegated with a customers' data, software, and computation. The application 214 may be arranged on a hardware and a software infrastructure. When the application 214 runs on the hardware and the software infrastructure, the infrastructure may utilize varying elements at a different level to deliver the service as per the service requirement. When elements in the infrastructure do not meet the utilization level, the application 214 may fail to provide the service as per the service requirement. When the application 214 fails to provide the service requirements, the elements in the infrastructure may be reconfigured and may be updated to meet the utilization level.

The service provisions may define the service requirements on a source cloud or on an initial datacenter and may not be automatically collected. As used herein, the service requirements may include, but are not limited to, a set of requirements that may be necessary to run an application in an infrastructure. The set of requirements may include, but are not limited to, database performance, application performance, network level performance, data security, information security, access control, privacy, scalability, trust, manageability, virtual machine requirements, and cost, among others. The service requirements may manifest into corresponding changes, modifications, configurations, and settings made to elements of the infrastructure, including hardware, software, network, and databases, as used herein.

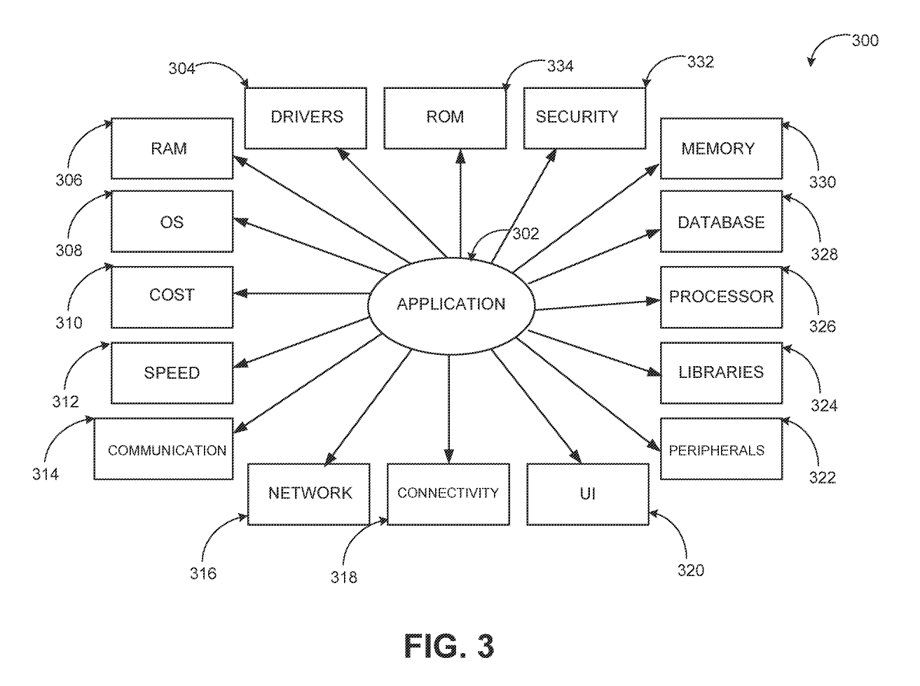

FIG. 3 illustrates application resources utilized to deliver the service provisions, arranged in accordance with at least some embodiments described herein.

As shown in a diagram 300, an application 302 may utilize various hardware resources and software resources to deliver the service level requirements. Each resource may be configured and adjusted to meet the service provisions, where the service provisions may include a driver 304, a random-access memory (RAM) 306, an operating system 308, a cost 310, a communication speed 312, a communication 314, a network 316, a connectivity 318, a user interface (UI) 320, a peripheral 322, a library 324, a processor 326, a database 328, a memory 330, a security 332, and a read-only memory (ROM) 334. The cost 310 may represent monetary or other cost of executing the application at the datacenter. The cost 310 may be based on usage of datacenter resources such as memory, hard disk capacity, processing capacity, and so on. The communication speed 312 may be a speed of communication enabled by the hosting datacenter between the executed application and the customer's users, for example. The communication 314 may include type and quality of communications. For example, a certain level of quality of service (QoS) with regard to communication between the users of the executed application may be guaranteed by the hosting datacenter. The peripheral 322 may refer to peripheral devices associated with the execution of the application such as dedicated security devices, scanners, printers, etc. The library 324 may refer to a library of executable modules that may be made available to the application by the hosting datacenter. For example, as the service provisions change, the change may manifest in a hardware resource and a software resource. In some examples, additional hardware resources may include a hard disk drive (HDD) (e.g., 4 TB), a physical memory (e.g., 16 GB), a total virtual memory (e.g., 4 GB), an available virtual memory (e.g., 2 GB), and an Ethernet cable speed (e.g., 1 GBPS).

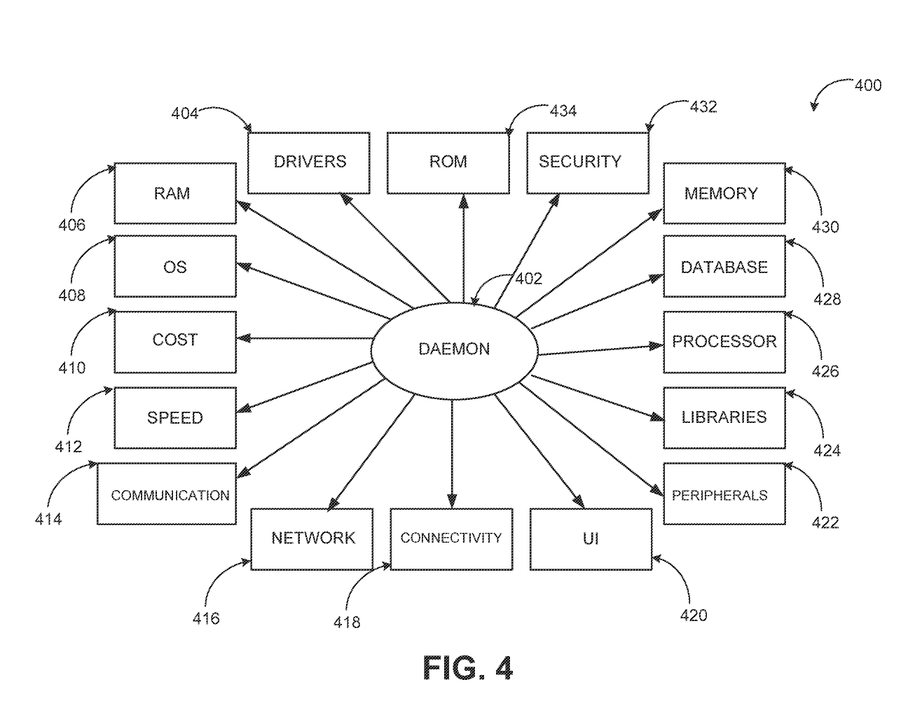

FIG. 4 illustrates the service provisions of application resources collected by a daemon, arranged in accordance with at least some embodiments described herein.

As shown in a diagram 400, a daemon 402 may collect configuration information of the hardware resources and the software resources of the application states of an application in an origin datacenter and a destination datacenter in real-time. Each resource may be configured and adjusted to meet the service provisions, where the service provisions may include a driver 404, a random-access memory (RAM) 406, an operating system 408, a cost 410, a communication speed 412, a communication 414, a network 416, a connectivity 418, a user interface (UI) 420, a peripheral 422, a library 424, a processor 426, a database 428, a memory 430, a security 432, and a read-only memory (ROM) 434. For example, as the service provision changes, the change may manifest in the hardware resources and software resources.

The daemon 402 may store the configuration information of each element in the database at different times, where the daemon 402 may store the service provisions, along with data. At a first time interval, initial values for hardware resources and software resources may be collected. In some of examples, as the time intervals increase, the hardware resources may continue to increase in a linear manner. In other embodiments, as the time intervals increase, the software resources may also continue to increase in a linear manner. In yet other examples, as the time intervals increase, the software resources may remain consistent.

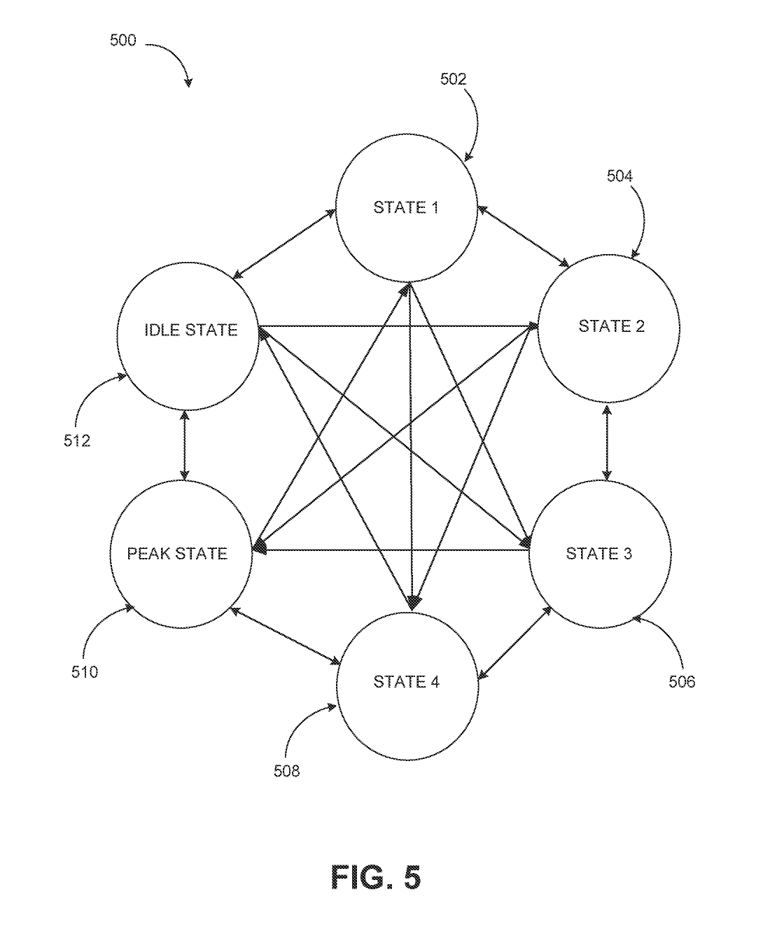

FIG. 5 illustrates an example configuration of multiple application states of applications in an origin datacenter and a destination datacenter, arranged in accordance with at least some embodiments described herein.

As illustrated in a diagram 500, a migration module may collect the service provisions (for example, continuously, periodically, or at random intervals) from a source infrastructure in a configurable number of times and durations. The migration module may operate at various different states. The migration module may run the application and may determine the needed service provisions for each state of the application including an idle state 512, selected active states among N active states, where the selected active states may include a first active state 502, a second active state 504, a third active state 506, and a fourth active state 508. Additionally, the active states may include a peak active state 510. The peak active state 510 may be where the migrating application's usage of resources is at a peak.

According to some embodiments, the migration module may be one or more of a daemon, an application, an engine, a migration application as part of a virtual machine, two independent modules, a bundle comprising a module wrapped around the application, or a third-party service, among others.

According to other embodiments, at the idle state 512, the migration module may collect the service provisions for each element, including, but not limited to, database performance, application performance, network performance, data security, information security, access control, privacy, scalability, trust, manageability, and cost, among others. At the first active state 502, the migration module may collect the same service provisions for each element that were collected in the idle state 512, including, but not limited to, database performance, application performance, network performance, data security, information security, access control, privacy, scalability, trust, manageability, and cost, among others.

According to some examples, the first active state 502 may have an enhanced level of data security. The second active state 504, may have an added level of data security from the first active state 502 and may have an added level of access speed. The migration module may also collect the same service provisions for each element that were collected in the idle state 512 and in the first active state 502. In the peak active state 510, the migration module may collect the service provisions for each element that were collected in the idle state 512, yet at the peak active state 510, the elements of the service provisions of the peak active state 510 may be at their top performance

According to further embodiments, a customer may selectively request one level of security at one state and another level of security at another state. The migration module may capture these security requirements for each state and ensure the destination virtual datacenter or destination infrastructure delivers the same. In some embodiments, the migration module may collect the service provisions for each state of the application and store the information, delivering the data to the destination virtual datacenter or destination infrastructure for each state of the application.

An example approach may be implemented in response to the service provisions being be collected from the idle state 512, the first active state 502, the second active state 504, the third active state 506, and the fourth active state 508, as illustrated in FIG. 5. The example approach may be implemented to test and re-test the service provisions in the source infrastructure or the source virtual datacenter. Testing and re-testing the service provisions may ensure that the service provisions collected from the migration module are an accurate representation of the source infrastructure or the source virtual datacenter. In some embodiments, a user interface module may be implemented to present the elements from the collected service provisions to the customer to allow the customer to update the service provisions as often as needed.

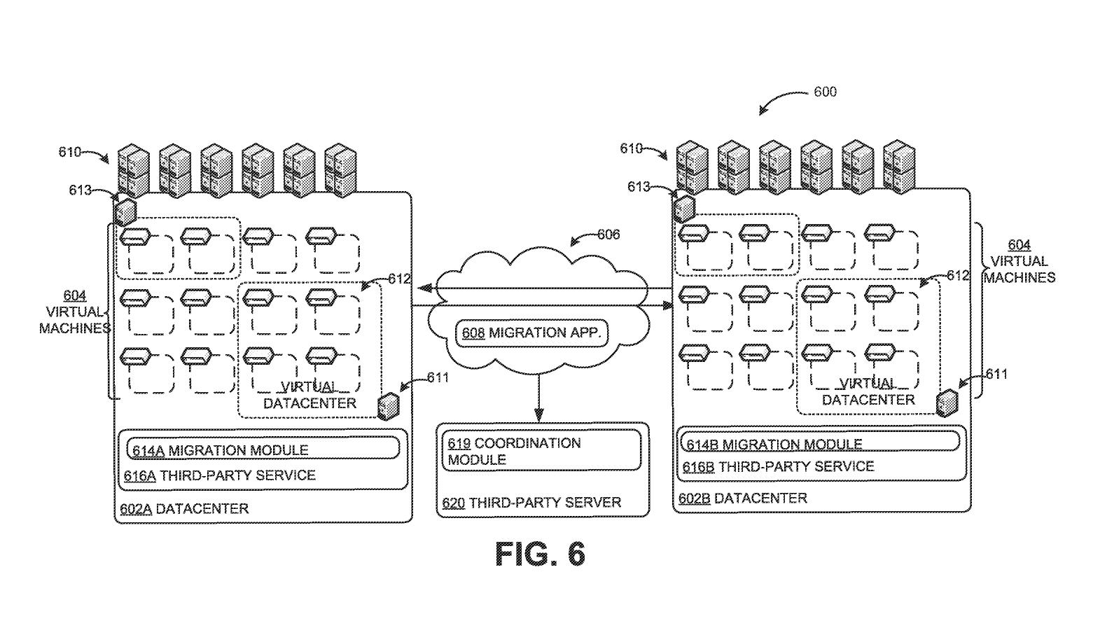

FIG. 6 illustrates an example configuration of a migration service configured to provide maintenance of resources in the migration of the applications deployed over multiple virtual servers, arranged in accordance with at least some embodiments described herein.

As illustrated in a diagram 600, datacenters 602A, 602B may include physical servers 610, 611, and 613, each of which may be configured to provide virtual machines 604. The datacenters 602A, 602B may include third-party services 616A, 616B, respectively. The third-party services 616A, 616B may include migration modules 614A, 614B, respectively. For example, the physical servers 611 and 613 may be configured to provide virtual machines 604. In some embodiments, the virtual machines 604 may be combined into virtual datacenters. For example, the virtual machines provided by the physical server 611 may be combined into the virtual datacenter 612. The virtual machines 604 and/or the virtual datacenter 612 may be configured to provide cloud-related data/computing services such as various applications, data storage, data processing, or comparable ones to a group of customers (such as individual customers or enterprise customers) or to the datacenters 602A, 602B, via a cloud environment 606.

According to some embodiments, the migration module 614A, 614B may be one of a daemon, an application, an engine, a migration application as part of the virtual machine 604, two independent modules, a bundle comprising a module wrapped around the application, or the third-party service 616A, 616B, as discussed previously.

According to a further embodiment, the migration module 614A may be executed at the datacenter 602A. The migration module 614B may be executed at the datacenter 602B. A coordination module 619 may be executed at one of the datacenter 602A, 602B, and/or a third-party server 620. The migration module 614A, 614B, and the coordination module 619 may also be executed together at one of the datacenters 602A, 602B, and/or the third-party server 620, according to some embodiments. In other embodiments, a combination of two of the migration modules 614A, 614B and the coordination module 619 may be integrated.

According to other embodiments, the migration of applications between the datacenters 602A and 602B may include a migration application 608 located in the cloud environment 606. The applications may be transferred through the cloud environment 606 via the migration application 608, which may include or coordinate operations of the coordination module 619 on the third-party server 620.

According to yet other embodiments, the coordination module 619 may, in response to a determination that the likelihood of successful deployment may be above a predefined threshold, instruct the migration module 614B to provision an infrastructure of the datacenter 602B. Successful deployment may be defined as execution of a migrating application at a destination environment at least at the same performance levels as at the source environment. In response to a determination that the likelihood of successful deployment may be above a predefined threshold, the coordination module 619 may additionally instruct the migration module 614B to deploy one or more applications at the datacenter 602B and instruct the migration module 614B to test the deployed applications in the provisioned infrastructure. The coordination module 619 may additionally instruct the migration module 614B to re-provision the infrastructure based on test results of the deployed applications, according to some examples.

In an example scenario, the data in the one or more applications to be migrated may be collected by the migration module 614A in form of the service provisions. The data may be moved from the datacenter 602A to the datacenter 602B. The service provisions defining the service requirements may be automatically collected in some examples.

In another example scenario, when transferring the one or more applications from the datacenter 602A to the datacenter 602B, the operating systems of the datacenters may not match. In such a scenario, the applications may have to be re-engineered in order for the applications to function in the destination datacenter.

While embodiments have been discussed above using specific examples, components, scenarios, and configurations in FIG. 1, FIG. 2, FIG. 3, FIG. 4, FIG. 5, and FIG. 6 are intended to provide a general guideline to be used to provide maintenance of resources in migration of an application between at least two datacenters. These examples do not constitute a limitation on the embodiments, which may be implemented using other components, optimization schemes, and configurations using the principles described herein. For example, other approaches may be implemented than those provided as example.

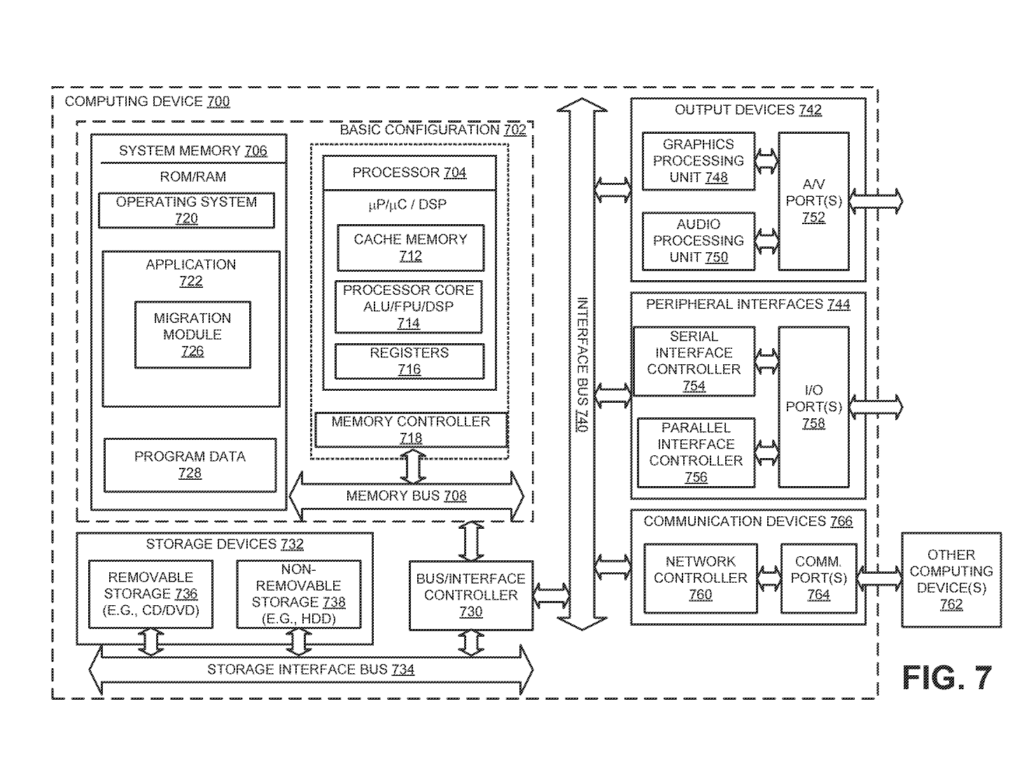

FIG. 7 illustrates a general purpose computing device, which may be used to provide maintenance of resources in migration of an application between at least two datacenters, arranged in accordance with at least some embodiments described herein.

For example, the computing device 500 may be used as the servers 104, 114, and/or 118 of FIG. 1. In an example basic configuration 702, the computing device 700 may include a processor 704 and a system memory 706. A memory bus 708 may be used for communicating between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, a processor core 714, and registers 716. The example processor core 714 may include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof. The system memory 706 may include an operating system 720, an application 722, a migration module 726, and program data 728. The application 722 may include the migration module 726. The migration module 726 may be configured to collect information associated with the resources for an execution of an application at an origin datacenter in the idle application state and one or more active application states. The migration module 726 may also be configured to determine corresponding resources associated with a deployment of the application at a destination infrastructure, as disclosed herein. The program data 728 may include, among other data, application data and the service provisions collected from source and destination datacenters, or the like, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and data storage devices 732 via a storage interface bus 734. The data storage devices 732 may be removable storage devices 736, non-removable storage devices 738, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any technique or technology for storage of information, such as computer readable instructions, data structures, program modules, or other data.

The system memory 706, the removable storage devices 736 and the non-removable storage devices 738 may be examples of computer storage media. Computer storage media includes, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (e.g., the output devices 742, the peripheral interfaces 744, and the communication devices 766) to the basic configuration 702 via the bus/interface controller 730. Some of the example output devices 742 include a graphics processing unit 748 and an audio processing unit 750, which may be configured to communicate to various external devices such as a display or speakers via A/V ports 752. Example peripheral interfaces 744 may include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via I/O ports 758. An example communication device 766 includes a network controller 760, which may be arranged to facilitate communications with other computing devices 762 over a network communication link via communication ports 764. The other computing devices 762 may include servers at a datacenter, customer equipment, and comparable devices.

The network communication link may be one example of a communication media. Communication media may be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to maintain application performances upon transfer between cloud servers. These methods can be implemented in any number of ways, including the structures described herein. One such way may be by machine operations, of devices of the type described in the present disclosure. Another optional way may be for the individual operations of the methods to be performed in conjunction with human operators performing some of the operations while other operations may be performed by machines. These human operators need not be co-located with each other, but each can be only with a machine that performs a portion of the program. In other examples, the human interaction can be automated such as by pre-selected criteria that may be machine automated.

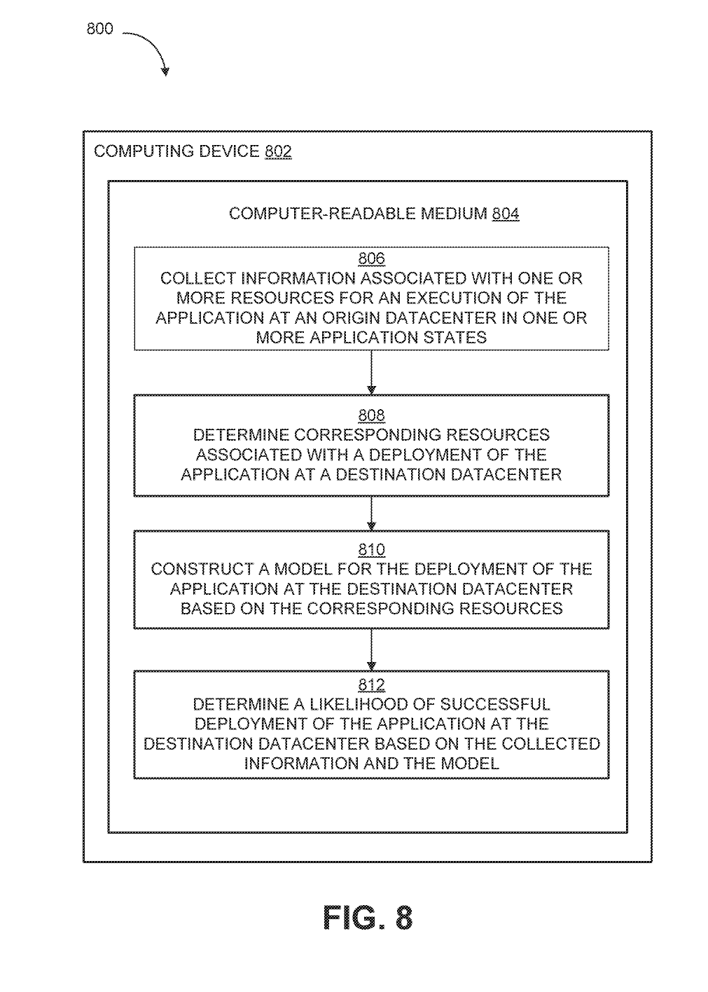

FIG. 8 illustrates a flow diagram illustrating an example method for providing maintenance of resources in migration of an application between at least two datacenters that may be performed by a computing device such as the computing device in FIG. 7, arranged in accordance with at least some embodiments described herein.

Example methods may include one or more operations, functions or actions as illustrated by one or more of blocks 806, 808, 810, and/or 812. The operations described in the blocks 806 through 812 may also be stored as computer-executable instructions in a computer-readable medium 804 of a computing device 802.

An example process for providing maintenance of resources in the migration of an application between at least two datacenters may be performed with block 806, “COLLECT INFORMATION ASSOCIATED WITH ONE OR MORE RESOURCES FOR AN EXECUTION OF THE APPLICATION AT AN ORIGIN DATACENTER IN ONE OR MORE APPLICATION STATES,” where a migration module (e.g., the migration module 614A of FIG. 6) may collect the service provisions in a scalable manner from the datacenter (e.g., the datacenter 602A of FIG. 6) a configurable number of times and durations. The migration module may collect information at various states of an application to be migrated.

Block 806 may be followed by block 808, “DETERMINE CORRESPONDING RESOURCES ASSOCIATED WITH A DEPLOYMENT OF THE APPLICATION AT A DESTINATION DATACENTER”, where the migration module (e.g., the migration module 614B, FIG. 6) may determine the service provisions for each state of the application to be migrated at the destination datacenter (e.g., the datacenter 602B of FIG. 6). In some embodiments, the migration module may test the service provisions collected to ensure the service provisions may be accurate.

Block 808 may be followed by block 810, “CONSTRUCT A MODEL FOR THE DEPLOYMENT OF THE APPLICATION AT THE DESTINATION DATACENTER BASED ON THE CORRESPONDING RESOURCES.” The model may be used to test deployability of the application at the destination datacenter, adjust service provisions based on customer requests, and determine any changes that may be needed to meet customer needs or destination datacenter service level requirements.

Block 810 may be followed by block 812, “DETERMINE A LIKELIHOOD OF SUCCESSFUL DEPLOYMENT OF THE APPLICATION AT THE DESTINATION DATACENTER BASED ON THE COLLECTED INFORMATION AND THE MODEL,” where the application may be deployed at the destination datacenter and tested. In response to an application being unable to function due to the service provisions of the datacenter, the service provisions may be modified. Once the service provisions of the destination datacenter are modified, the updated datacenter and the service provisions may be tested and re-tested. The application may also be re-engineered at the destination datacenter, if necessary.

The migration module may also be part of a virtual machine. The service provisions, the configuration data, the applications, data models, data, and additional information, among others may be packaged as part of the virtual machine. The virtual machine package may be moved from a source infrastructure to a destination infrastructure. The virtual machine may have the code for both the source migration functionality and the target migration functionality. When the virtual machine moves from the source infrastructure to the destination infrastructure, the code for the target migration module may be activated and may install the virtual machine automatically. In addition, the migration module may perform the functions discussed earlier and deploy the application automatically within the virtual machine.

The blocks included in the above described process are for illustration purposes. Maintenance of application resources in the migration of applications between datacenters through the use of a migration module. In some examples, the blocks may be performed in a different order. In some other examples, various blocks may be eliminated. In still other examples, various blocks may be divided into additional blocks, or combined together into fewer blocks.

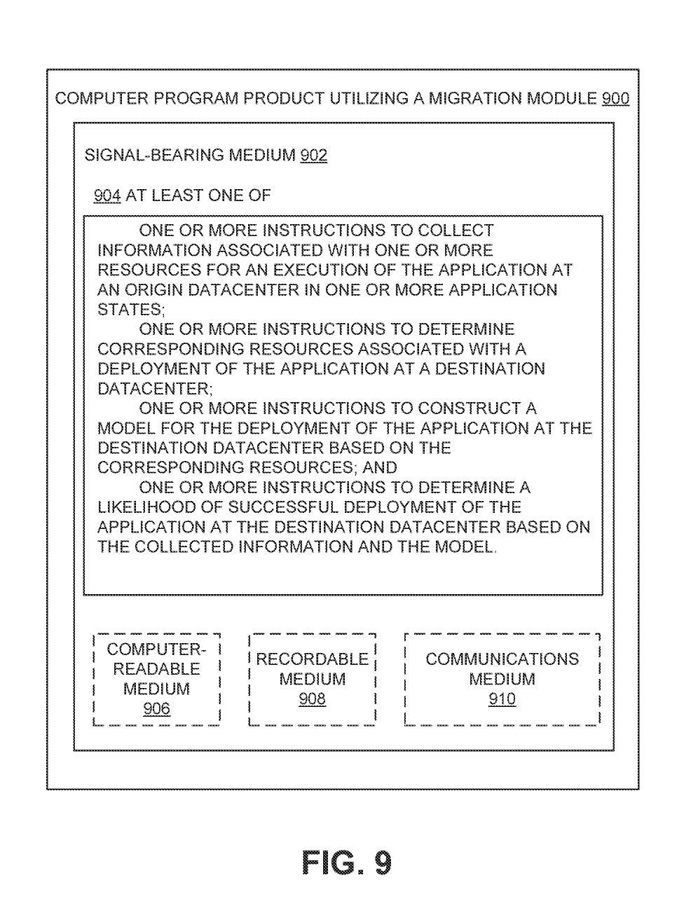

FIG. 9 illustrates a block diagram of an example computer program product utilizing a migration module, arranged in accordance with at least some embodiments described herein.

In some examples, as shown in FIG. 9, the computer program product 900 may include a signal bearing medium 902 that may also include machine readable instructions 904 that, when executed by, for example, a processor, may provide the functionality described herein. For example, referring to FIG. 6, the migration modules 614A, 614B may undertake one or more of the tasks shown in FIG. 7 in response to the instructions 904 conveyed to the processor 704 by the medium 902 to perform actions associated with maintenance of resources in the migration of applications between datacenters through the use of a migration module as described herein. Some of those instructions may include, for example, instructions to collect information associated with one or more resources for an execution of the application at an origin datacenter in one or more application states. The instructions may additionally include to determine corresponding resources associated with a deployment of the application at a destination datacenter and to construct a model for the deployment of the application at the destination datacenter based on the corresponding resources. The instructions may further include to determine a likelihood of successful deployment of the application at the destination datacenter based on the collected information and the model, according to some embodiments described herein.

In some implementations, the signal bearing medium 902 depicted in FIG. 9 may encompass a computer-readable medium 906, such as, but not limited to, a hard disk drive, a solid state drive, a Compact Disc (CD), a Digital Versatile Disk (DVD), a digital tape, memory, etc. In some implementations, the signal bearing medium 902 may encompass a recordable medium 908, such as, but not limited to, memory, read/write (R/W) CDs, R/W DVDs, etc. In some implementations, the signal bearing medium 902 may encompass a communications medium 910, such as, but not limited to, a digital and/or an analog communication medium (e.g., a fiber optic cable, a waveguide, a wired communications link, a wireless communication link, etc.). For example, the program product utilizing a migration module 900 may be conveyed to modules of the processor 904 by an RF signal bearing medium, where the signal bearing medium 902 may be conveyed by the wireless communications medium 910 (e.g., a wireless communications medium conforming with the IEEE 802.11 standard).

According to some embodiments, methods to maintain resources in the migration of an application between datacenters are described. An example method may include collecting information associated with one or more resources for an execution of the application at an origin datacenter in one or more application states, determining corresponding resources associated with a deployment of the application at a destination datacenter, constructing a model for the deployment of the application at the destination datacenter based on the corresponding resources, and determining a likelihood of successful deployment of the application at the destination datacenter based on the collected information and the model.

According to further embodiments, the method may further include enabling an owner of the application to modify the collected information. Collecting information associated with the one or more resources may include collecting information associated with service provisions and one or more configuration settings of the application at the origin datacenter.

According to some embodiments, the method may further include translating the service provisions into data and the application level service provisions. The one or more application states may include an idle state an active state. The one or more active state may include one of: a peak processing state, a peak communication state, a low processing state, or a low communication state.

According to further embodiments, the method may further include testing the model at the origin datacenter to enhance an accuracy of the collected information. The method may further include packaging one or more of the collected information and the model with the application and transferring the packaged application to the destination datacenter for the deployment.

According to some embodiments, in response to a determination that the likelihood of successful deployment may be above a predefined threshold, the method may further include provisioning an infrastructure of the destination datacenter and deploying the application at the destination datacenter. The method may further include upon deployment of the application at the destination datacenter, testing the deployed application in the provisioned infrastructure and re-provisioning the infrastructure based on test results of the deployed application.

According to further embodiments, the method may further include testing the deployed application at the destination datacenter in the one or more application states. One or more resources may include a hardware resource and a software resource.

According to further embodiments, a computing device to maintain resources in the migration of an application between datacenters may include a memory and a processor coupled to the memory and adapted to execute a migration module. The migration module may collect information associated with one or more resources for an execution of the application at an origin datacenter in one or more of an idle application state and one or more active application states, determine corresponding resources associated with a deployment of the application at a destination datacenter, construct a model for the deployment of the application at the destination datacenter based on the corresponding resources, determine a likelihood of successful deployment of the application at the destination datacenter based on the collected information and the model, package one or more of the collected information and the model with the application, and transfer the packaged application to the destination datacenter for the deployment.

According to some embodiments, the migration module may collect information in real-time from one or more of the origin datacenter and the destination datacenter in the one or more application states. The migration module may collect information associated with the service provisions and one or more configuration settings of the application at the origin datacenter and may translate the service provisions into data and application level service provisions.

According to further embodiments, the service provisions may include one or more of: a database performance, an application performance, a network level performance, a data security, an information security, an access control, a privacy, a scalability, a trust level, a manageability, a virtual machine requirement, and a cost consideration.

According to additional embodiments, in response to a determination that the likelihood of successful deployment may be above a predefined threshold, the migration module may be further configured to provision an infrastructure of the destination datacenter, deploy the application at the destination datacenter, test the deployed application in the provisioned infrastructure, and re-provision the infrastructure based on test results of the deployed application.

According to further embodiments, the migration module may collect information associated with one or more of a hardware component, a software component, a database component, and a cost component at the origin datacenter and the destination datacenter. The migration module may provide a user interface to enable performance of one or more of: an edit, an update, and a prioritization of the service provisions.

According to additional embodiments, the migration module may be one of a daemon, an application, an engine, a migration application as part of a virtual machine, two independent modules, a bundle comprising a module wrapped around the application, or a third-party service.

According to further embodiments, a migration service to maintain resources in the migration of an application between datacenters, may include a first migration module, a second migration module, and a coordination module. The first migration module may be configured to collect information associated with one or more resources for an execution of the application at an origin datacenter in one or more of an idle application state and one or more active application states. The second migration module may be configured to determine corresponding resources associated with a deployment of the application at a destination datacenter. The coordination module may be configured to construct a model for the deployment of the application at the destination datacenter based on the corresponding resources at the destination datacenter, determine a likelihood of successful deployment of the application at the destination datacenter based on the collected information and the model, package one or more of the collected information and the model with the application, and transfer the packaged application to the destination datacenter for the deployment.

According to further embodiments, at least two of the first migration module, the second migration module, and the coordination module may be integrated. The first migration module may be executed at the origin datacenter, the second migration module may be executed at the destination datacenter, and the coordination module may be executed at one of: the origin datacenter, the destination datacenter, and a third-party server.

According to some embodiments, the first migration module, the second migration module, and the coordination module may be executed together at one of: the origin datacenter, the destination datacenter, and a third-party server. The collected information may be associated with one or more of: a database performance, an application performance, a network level performance, a data security, an information security, an access control, a privacy, a scalability, a trust level, a manageability, a virtual machine requirement, and a cost consideration.

According to further embodiments, in response to a determination that the likelihood of successful deployment may be above a predefined threshold, the coordination module may be further configured to instruct the second migration module to provision an infrastructure of the destination datacenter. The coordination module may also instruct the second migration module to deploy the application at the destination datacenter, instruct the second migration module to test the deployed application in the provisioned infrastructure, and instruct the second migration module to re-provision the infrastructure based on test results of the deployed application.

According to further embodiments, the first migration module may collect information associated with one or more of a hardware component, a software component, a database component, and a cost component at the origin datacenter and the destination datacenter. The coordination module may provide a user interface to enable performance of one or more of: an edit, an update, and a prioritization of the service provisions.

According to other embodiments, the first migration module may test the model at the origin datacenter to enhance an accuracy of the collected information.

According to some embodiments, a computer readable storage medium with instructions stored thereon, which when executed on one or more computing devices executes a method for maintenance of resources in migration of an application between datacenters is described. An example method may include the actions described above.

There may be little distinction left between hardware and software implementations of aspects of systems; the use of hardware or software is generally (but not always, in that in certain contexts the choice between hardware and software may become significant) a design choice representing cost vs. efficiency tradeoffs. There may be various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via

Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g. as one or more programs running on one or more microprocessors), as firmware, or as virtually any combination thereof, and that designing the circuitry and/or writing the code for the software and or firmware would be well within the skill of one of skill in the art in light of the disclosure.

The present disclosure is not to be limited in terms of the particular embodiments described in the application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the disclosure is not limited to particular methods, reagents, compounds compositions or biological systems, which can, of course, vary. It is also to be understood that the terminology used herein is for the purpose of describing particular embodiments only, and is not intended to be limiting.

In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, a solid state drive, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces (GUIs), and applications programs, one or more interaction devices, such as a touch pad or screen, and/or control systems including feedback loops and control motors (e.g., feedback for sensing position and/or velocity of gantry systems; control motors for moving and/or adjusting components and/or quantities).

A typical data processing system may be implemented utilizing any suitable commercially available components, such as those found in data computing/communication and/or network computing/communication systems. The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (e.g.,“a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. For example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for maintenance of resources in migration of an application between datacenters, the method comprising:
collecting information associated with one or more resources for an execution of the application at an origin datacenter in one or more application states, wherein the one or more application states include an idle state or one of a plurality of active states;
determining corresponding resources associated with a deployment of the application at a destination datacenter;
constructing a model for the deployment of the application at the destination datacenter based on the corresponding resources; and
determining a likelihood of successful deployment of the application at the destination datacenter based on the collected information and the model.

2. The method of claim 1, further comprising:
enabling an owner of the application to modify the collected information.

3. The method of claim 1, wherein collecting information associated with the one or more resources comprises:
collecting information associated with service provisions and one or more configuration settings of the application at the origin datacenter.

4. The method of claim 3, further comprising:
translating the service provisions into data and application level service provisions.

5. (canceled)

6. (canceled)

7. The method of claim 1, further comprising:
testing the model at the origin datacenter to enhance an accuracy of the collected information.

8. The method of claim 1, further comprising:
packaging at least one of the collected information and the model with the application; and
transferring the packaged application to the destination datacenter for the deployment.

9. The method of claim 1, further comprising:
in response to a determination that the likelihood of successful deployment is above a predefined threshold, provisioning an infrastructure of the destination datacenter and deploying the application at the destination datacenter.

10. The method of claim 9, further comprising:
upon deployment of the application at the destination datacenter, testing the deployed application in the provisioned infrastructure; and
re-provisioning the infrastructure based on test results of the deployed application.

11. The method of claim 10, further comprising:
testing the deployed application at the destination datacenter in the one or more application states.

12. (canceled)

13. A computing device configured to provide maintenance of resources in migration of an application between datacenters, the computing device comprising:
a memory;
a processor coupled to the memory and adapted to execute a migration module that is configured to:
collect information associated with one or more resources in real-time from one or more of an origin datacenter and a destination datacenter for an execution of the application at the origin datacenter in one or more of an idle application state and one or more of a plurality of active application states;
determine corresponding resources associated with a deployment of the application at the destination datacenter;
construct a model for the deployment of the application at the destination datacenter based on the corresponding resources;
determine a likelihood of successful deployment of the application at the destination datacenter based on the collected information and the model;
package at least one of the collected information and the model with the application; and
transfer the packaged application to the destination datacenter for the deployment.

14. (canceled)

15. The computing device of claim 13, wherein the migration module is further configured to:
collect information associated with service provisions and one or more configuration settings of the application at the origin datacenter; and
translate the service provisions into data and application level service provisions.

16. (canceled)

17. The computing device of claim 13, wherein the migration module is further configured to:
in response to a determination that the likelihood of successful deployment is above a predefined threshold, provision an infrastructure of the destination datacenter;
deploy the application at the destination datacenter;
test the deployed application in the provisioned infrastructure; and
re-provision the infrastructure based on test results of the deployed application.

18. (canceled)

19. The computing device of claim 13, wherein the migration module is further configured to provide a user interface to enable performance of one or more of: an edit, an update, and a prioritization of one or more service provisions.

20. The computing device of claim 13, wherein the migration module is one of a daemon, an application, an engine, a migration application as part of a virtual machine, two independent modules, a bundle comprising a module wrapped around the application, or a third-party service.

21. A migration service configured to provide maintenance of resources in migration of an application between datacenters, the migration service comprising:
a first migration module executed at an origin datacenter, wherein the first migration module is configured to:
collect information associated with one or more resources for an execution of the application at the origin datacenter in one or more of an idle application state and one or more of a plurality of active application states;
a second migration module executed at a destination datacenter, wherein the second migration module is configured to:
determine corresponding resources associated with a deployment of the application at the destination datacenter; and
a coordination module executed at one of: the origin datacenter, the destination datacenter, and a third-party server, wherein the coordination module is configured to:
construct a model for the deployment of the application at the destination datacenter based on the corresponding resources at the destination datacenter;
determine a likelihood of successful deployment of the application at the destination datacenter based on the collected information and the model;
package at least one of the collected information and the model with the application; and
transfer the packaged application to the destination datacenter for the deployment.

22. The migration service of claim 21, wherein at least two of the first migration module, the second migration module, and the coordination module are integrated.

23. (canceled)

24. The migration service of claim 21, wherein the first migration module, the second migration module, and the coordination module are executed together at one of: the origin datacenter, the destination datacenter, and a third-party server.

25. (canceled)

26. The migration service of claim 21, wherein the coordination module is further configured to:
in response to a determination that the likelihood of successful deployment is above a predefined threshold, instruct the second migration module to provision an infrastructure of the destination datacenter;
instruct the second migration module to deploy the application at the destination datacenter;
instruct the second migration module to test the deployed application in the provisioned infrastructure; and
instruct the second migration module to re-provision the infrastructure based on test results of the deployed application.

27. (canceled)

28. The migration service of claim 21, wherein the coordination module is further configured to provide a user interface to enable performance of one or more of: an edit, an update, and a prioritization of one or more service provisions.

29. The migration service of claim 21, wherein the first migration module is further configured to test the model at the origin datacenter to enhance an accuracy of the collected information.

30. (canceled)
